(19) United States
(12) Patent Application Publication
(10) Pub. No.: US 2023/0110593 A1
(43) Pub. Date: Apr. 13, 2023

(54) INSTALLATION AID CHAIN, INSTALLATION AID CHAIN, COIL ARRANGEMENT WITH THE SAME, AND METHOD FOR PRODUCING A COIL ARRANGEMENT FOR A VEHICLE-SIDE INDUCTION CHARGING UNIT CHARGING UNIT WITH AN INSTALLATION AID CHAIN

(71) Applicant: Mahle International GmbH, Stuttgart (DE)

(72) Inventors: Timo Laemmle, Kernen (DE); Holger Schroth, Maulbronn (DE); Markus Watzlawski, Esslingen (DE)

(21) Appl. No.: 17/957,991

(22) Filed: Sep. 30, 2022

(30) Foreign Application Priority Data
Sep. 30, 2021 (DE) 102021211036.3

(51) Int. Cl. H01F 41/082; H01F 41/063

(52) U.S. Cl. CPC H01F 41/082; H01F 41/063

(57) ABSTRACT

An installation aid chain member for an installation aid chain may be arranged for positioning and fixing an electric conductor. The installation aid chain member may include a base, at least one coupling arrangement, and a conductor holder. The base may define a support surface. The support surface may support or be able to support the installation aid chain member. The at least one coupling arrangement may be arranged on the base for movably coupling the installation aid chain member to a second installation aid chain member. The conductor holder may be arranged away from the support surface on the base, for retaining a conductor portion of the electric conductor.

### CROSS-REFERENCE TO RELATED APPLICATIONS

This application claims priority to German Patent Application No. 10 2021 211 036.3, filed on Sep. 30, 2021, the contents of which is hereby incorporated by reference in its entirety.

### TECHNICAL FIELD

The invention relates to an installation aid chain. The invention further relates to an installation aid chain and a coil arrangement with same. Furthermore, the invention relates to a method for producing a coil arrangement for a vehicle-side induction charging unit with an installation aid chain.

### BACKGROUND

For contactless energy transfer between an induction charging unit arranged onboard the vehicle and a mutual induction charging unit anchored on the ground, in order to be able to realize an efficient energy transfer, an optimum magnetic coupling must be set between these. In practice, this is achieved substantially through a structural coordination of the components of the vehicle-side induction charging unit to the mutual induction charging unit. In order to save on development work and development costs, it is desired nowadays in prevalent platform strategies to standardize the vehicle-side induction charging unit and to realize a usage which is as wide as possible across motor vehicle types. As, however, vehicle-side boundary conditions, such as ground clearance etc. differ in part considerably from motor vehicle type to motor vehicle type, in order to nevertheless be able to provide an optimum magnetic coupling between the induction charging unit and the mutual induction charging unit, the motor vehicle-side induction charging unit must be adapted in particular with regard to its magnetic characteristics, which is achieved in practice for example through a structural adaptation of its coil arrangement. However, the adaptations which are to be carried out entail relatively high costs, although economical solutions are desired. Further, it is conceivable in addition that a flexibly adaptable installation device on the ground-side mutual induction charging unit also assists any design changes in a positive manner.

### SUMMARY

The object of the invention lies in overcoming the previously known disadvantages, in particular an improved or at least a different embodiment of a coil arrangement for a vehicle-side induction charging unit is to be provided or indicated.

In the present invention, this problem is solved by the subject matter of the independent claim(s). Advantageous embodiments are the subject of the dependent claim(s) and the description.

The basic idea of the invention lies in simplifying the positioning and fixing of an electric conductor, forming a flat coil of the coil arrangement, on a mounting area of an induction charging unit by means of an installation aid.

For this, the invention proposes an installation aid chain member for an installation aid chain, arranged for positioning and fixing an electric conductor, which installation aid chain has a base, defining a support surface, via which the installation aid chain member is expediently supported or able to be supported, touching on a mounting area of an induction charging arrangement. The installation aid chain member has, furthermore, at least one coupling arrangement, arranged on the base, for the movable, in particular rotatably movable, coupling of the installation aid chain member with at least one further installation aid chain member. The installation aid chain member has, furthermore, a conductor holder for retaining a conductor portion of an electric conductor, which is arranged away from the said support surface on the base. The installation aid chain member can be coupled by means of the at least one coupling arrangement, preferably by means of two separate coupling arrangements, with at least one further installation aid chain member according to the invention, preferably with respectively two further installation aid chain members according to the invention, detachably or non-detachably, to form a flexible installation aid chain. The respective installation aid chain members are coupled to one another movably, in particular rotatably movably, here, i.e. movably relative to one another, so that the installation aid chain can be laid practically without expenditure of force and flexibly into a predetermined shape contour, for example into a flat or multi-dimensional spiral shape, and can be positioned and fixed via the support surfaces of the bases of its installation aid chain members according to the invention for example on a mounting area of an induction charging unit. An electric conductor, which is or becomes retained at least on a conductor portion by the conductor holder of the installation aid chain member according to the invention, takes over or copies, as it were, the shape contour predetermined by the installation aid chain, so that a flat coil can be realized on the mounting area of the induction charging unit when the shape contour, predetermined by the installation aid chain, defines a spiral shape. The laying direction of the installation aid chain therefore corresponds to the laying direction of the electric conductor of the flat coil.

It is expedient if the conductor holder has at least one holding portion for receiving and retaining the conductor portion of the electric conductor.

Here, at least one holding portion can be realized by a recess mount, curved in a concave manner, on the recess support surface of which, in particular oriented opposed to the base, the conductor portion of the electric conductor is arranged, in particular is fixed and preferably bonded adhesively.

Alternatively thereto, at least one holding portion can be realized by a two-winged clamp. Between the two clamping wings of the clamp, lying opposite one another, a clamp mount is delimited or formed, into which the conductor portion of the electric conductor is inserted or is able to be inserted. When the conductor portion of the electric conductor is inserted into the clamping mount, the clamping wings here can preferably lie touching on the conductor portion of the electric conductor and clamp the electric conductor. It is expedient if at least one clamping wing or both clamping wings have elastic characteristics, so that on inserting of a conductor portion of the electric conductor they carry out a certain elastic deflection and, if applicable, can lie touching on the conductor portion with elastic prestressing. It is further expedient if at least one clamping wing or both clamping wings are embodied in a slitted manner, for example transversely to the electric conductor. With the slitting of a clamping wing, its clamping wing cross-section is reduced, which is connected with a reduction of the clamping wing moment of resistance, so that the clamping wing deforms elastically with little expenditure of force. The flexibility of the clamping wings is thereby noticeably increased.

Furthermore, alternatively provision can be made that the at least one holding portion is realized by a u-shaped groove with undercut, coordinated in an accurately fitting manner to the conductor portion of the electric conductor. Thereby, as a whole several advantageous variants are indicated for holding portions which are able to be produced economically, with which a conductor portion of the electric conductor can be received and fixed on the respective installation aid chain member.

The conductor holder can preferably have two separate holding portions, spaced apart from one another, by means of which respectively a conductor portion of the electric conductor is able to be received and retained. Thereby, the installation aid chain member can retain the electric conductor, as it were, at two separate locations, spaced apart from one another, whereby the positionability of the electric conductor is improved. Expediently, the two holding portions have a first distance from one another which is identical or at least practically identical to a second distance, which is between the one or other holding portion of these two holding portions of this installation aid chain member and an immediately adjacent holding portion, with respect to this holding portion, of a further adjacent installation aid chain member.

Expediently, the said conductor holder can have at least one support portion which is formed integrally on the at least one holding portion, so that the conductor holder forms a monolithic component. The support portion can be arranged on the base, so that the at least one holding portion can rest on the base via the said support portion. Here, between the at least one holding portion and the base, a holding portion-base distance is expediently set, which can be varied by a predetermined or predeterminable support portion component height of the support portion, so that the holding portion-base distance can be set according to requirements. Thereby, it is possible that the installation aid chain member carries the conductor portion of the electric conductor with a predetermined or predeterminable distance with respect to a mounting area of an induction charging unit, on which the base rests with its support surface in the mounted state of the installation aid chain member. This has the advantage that a sufficient electrical insulation can be guaranteed.

It is further expedient if the at least one holding portion is arranged for receiving and retaining the conductor portion of the electric conductor so that electric conductors of different conductor cross-section can also be received and retained. Thereby, the conductor cross-section of an electric conductor can be varied and, for example, adapted to a predetermined battery voltage and/or a predetermined battery current. In other words, the current-carrying capacity of the electric conductor is thereby able to be adapted in wide ranges, so that the installation aid chain members can also be adapted to 400 Volt battery systems or 800 Volt battery systems.

It is further expedient if the at least one coupling arrangement is embodied integrally with the base, or is provided as a separate component and arranged on the base.

It is furthermore expedient if the installation aid chain member has two coupling arrangements, which are arranged on base end faces of the base which are oriented opposed to one another. Thereby, the installation aid chain member can be coupled to two further installation aid chain members.

Furthermore, it can be expedient if the two coupling arrangements are formed in a complementary manner to one another, whereby the two coupling arrangements are coupled or able to be coupled in a form-fitting and/or force-fitting manner expediently respectively with a complementary coupling arrangement of a further installation aid chain member. Thereby, the installation aid chain members can be connected relatively simply, if applicable without a special tool and manually, to one another to form an installation aid chain.

It is furthermore expedient if a first coupling arrangement of these two coupling arrangements is realized by an external circular cylinder plate, projecting with respect to the base, and a second coupling arrangement of these two coupling arrangements is realized by an external circular cylinder plate mount, projecting with respect to the base. It is expedient here if the circular cylinder plate is aligned with its flat plate large surfaces parallel to the support surface of the base. Furthermore, provision can also be made that a first coupling arrangement of these two coupling arrangements is realized by an external ball bar, projecting with respect to the base, and a second coupling arrangement of these two coupling arrangements is realized by an external ball bar mount, projecting with respect to the base. Furthermore, it is conceivable that first coupling arrangement of these two coupling arrangements is realized by an external ball hook, projecting with respect to the base, and a second coupling arrangement of these two coupling arrangements is realized by an external ball hook mount, projecting with respect to the base. Thereby, advantageous coupling arrangements are indicated which are able to be produced economically and by means of simple tools.

Furthermore, provision can be made that the two coupling arrangements define in their main extent direction a laying direction of the installation aid chain member, wherein the base end faces are oriented perpendicularly with respect to the laying direction. Here, a first external coupling arrangement of these two coupling arrangements, with respect to the base, can be arranged in or in the region of a base end face centre at the one, first base end face of these two base end faces on the base. In particular, the first coupling arrangement can be arranged at a centre of area of this base end face or centrally with respect to a base end face width of this base end face. In any case, provision is made furthermore that a second internal coupling arrangement of these two coupling arrangements, with respect to the base, is arranged in the base and opens out at least in or in the region of a base end face centre at the other, second base end face of these two base end faces. In particular, the second coupling arrangement can open out at a centre of area of this base end face or centrally with respect to a base end face width of this base end face. Thereby, a preferred variant of advantageous coupling arrangements, able to be produced economically and by means of simple tools, is indicated.

Furthermore, it is expedient if the first, external coupling arrangement has an, in particular bar-shaped, coupling projection arranged on the first base end face on the base, and a coupling element, able to be coupled movably with a coupling counter-element, wherein the coupling projection projects over the first base end face in the direction of the laying direction and carries the coupling element at its free end. Furthermore, provision is made that the second, internal coupling arrangement has a coupling counter-element, arranged internally in the base, able to be movably coupled with a coupling element, and has a connecting neck opening out on the one hand on the second base end face and on the other hand on the second coupling counter-element, cooperating with a coupling projection. Expediently, the coupling projection of the first coupling arrangement has a width or a diameter which corresponds to 0.05 to 0.3 times the base width of the base which is to be further defined in the following. Hereby, a preferred embodiment which is technically simple to implement is indicated for coupling arrangements.

It is expedient here if the said coupling element is realized by a sphere or an ovoid or a circular cylinder plate and/or the coupling counter-element is realized by a spherical recess, in particular a hemispherical recess, formed integrally into the base and open on one side, or by a circular cylinder plate recess, formed integrally into the base and open on one side. It is expedient here if the circular cylinder plate is aligned with its flat plate large surfaces parallel to the support surface of the base. Thereby, different configurations are indicated for the coupling element and the coupling counter-element. These configurations are, however, not to be understood as a conclusive list, rather any desired complementary configurations can be selected for the coupling element and the coupling counter-element.

The said coupling element of the installation aid chain member, if it is realized in the form of a circular cylinder plate and is movably coupled to a coupling counter-element of a further installation aid chain member realized as a circular cylinder plate recess, can realize a relative movement of the further installation aid chain member with respect to the installation aid chain member, in which the further installation aid chain member can be displaced about a pivot centre vertical axis defined by a circular cylinder plate centre of the circular cylinder plate, in a horizontal plane which is arranged parallel to the support surface of the base of the installation aid chain member. Thereby, an installation aid chain formed from the installation aid chain members can be handled in a relatively flexible manner and for example can realize the shape contour of a planar curve.

Furthermore, the said coupling element of the installation aid chain member, when it is realized in the form of a sphere and is movably coupled to a coupling counter-element, realized as a spherical recess, of a further installation aid chain member, can realize a relative movement of the further installation aid chain member with respect to the installation aid chain member, in which the further installation aid chain member can be displaced about a pivot centre vertical axis which is defined by a sphere centre line of the sphere standing perpendicularly on the support surface of the base of the installation aid chain member, and about a pivot transverse axis standing perpendicularly on the pivot centre vertical axis. Thereby, an installation aid chain, formed from the installation aid chain members, can have for example a planar but also a non-planar, three-dimensional shape contour. Hereby, it is possible to guide the installation aid chain along on a non-planar mounting area of the induction arrangement, having for example jumps and/or steps and/or inclines.

Provision can further be made that the coupling element of the first, external coupling arrangement is greater than the coupling projection. In particular, the diameter of the said sphere can be greater than the coupling projection carrying it. Preferably, the diameter of the sphere can correspond to 1.5 to 3.0 times the width of the coupling projection or 1.5 to 3.0 times the diameter of the coupling projection. Furthermore, in particular the diameter of the said ball plate can be greater than the coupling projection carrying it. The diameter of the sphere can preferably be 1.5 to 3.0 times the width of the coupling projection or 1.5 to 3.0 times the diameter of the coupling projection. Expediently, the said spherical recess has an internal dimension, in particular an internal diameter, which is dimensioned somewhat greater than a width or a diameter of the said sphere, whereby the sphere can be inserted relatively easily and with little expenditure of force into the spherical recess.

The coupling counter-element and/or the connecting neck of the second, internal coupling arrangement can have elastic characteristics. Thereby, the coupling counter-element and/or the connecting neck can be elastically deformed within certain limits. It is conceivable that thereby the coupling of coupling element and coupling counter-element can be facilitated. For example, it can be conceived that the coupling counter-element widens elastically within certain limits on inserting of the coupling element, and lies in a clamping manner against the fully inserted coupling element. Furthermore, it can be conceived that the connecting neck widens elastically within certain limits on inserting of the coupling element and, as soon as the coupling element is fully inserted, springs back elastically again, so that the connecting neck and the coupling element delimit at least in part a form-fitting undercut, which functions as a disengagement protection. Thereby, the installation aid chain members can be equipped with a certain security against undesired disengagement, which benefits the handling of the installation aid chain. The said elastic characteristics can be realized, if applicable, by the introducing of slits.

Further expediently, the second coupling arrangement can be equipped with at least one position-securing element, inserted in particular into the coupling counter-element and/or into the connecting neck, which prevents an unintentional disengaging of the installation aid chain members. Such position-securing elements can preferably be used when the coupling element is realized by a circular cylinder plate and the coupling counter-element is realized by a circular cylinder plate mount or a circular cylinder plate recess. The position-securing element can be provided either as a separate component and can be mounted on the base on the coupling arrangement or can be embodied integrally with the base. Expediently, the position-securing element is realized by an economical securing ring.

Expediently, the coupling projection of the first, external coupling arrangement of the installation aid chain member and the connecting neck of the second, internal coupling arrangement of a further installation aid chain member, when the installation aid chain member and the further installation aid chain member are coupled via this first, external coupling arrangement and this second, internal coupling arrangement, and/or the coupling projection of the first, external coupling arrangement of a further installation aid chain member and the connecting neck of the second, internal coupling arrangement of the installation aid chain member, when the installation aid chain member and this further installation aid chain member are coupled via this first, external coupling arrangement and this second, internal coupling arrangement, form respectively a stop through which a relative movement of the further installation aid chain members is delimited or is able to be delimited with respect to the installation aid chain member. Expediently, the coupling projections respectively abut against least one wall of the coupling recesses. Thereby, for example, a minimum curve radius of an installation aid chain, formed from the installation aid chain members, can be predetermined.

It is expedient if the base is formed by a cuboid-shaped flat body, which in its main extent direction defines a base length and transversely to the main extent direction in a transverse direction defines a base width, wherein the base width of the base is dimensioned so that in transverse direction to the main extent direction of the installation aid chain member closely adjacent further installation aid chain members, i.e. resting on the base of the installation aid chain member and frequently running in a largely parallel main extent direction, are arranged so that the conductor portion carried by the installation aid chain member and the conductor portion carried by the further installation aid chain member have a sufficiently great minimum distance with respect to one another, whereby an efficient electrical insulation of the conductor portions of the electric conductor, carried by the installation aid chain members, can be achieved.

Expediently, the bases of installation aid chain members, which are coupled to one another, can delimit a relative movement of the installation aid chain members with respect to one another, by the bases of two immediately adjacent installation aid chain members abutting against one another. Hereby, for example a minimum curve radius of an installation aid chain, formed from the installation aid chain members, can be predetermined.

A minimum curve radius can also be predetermined in that a distance between two adjacent installation aid chain members, coupled to one another, and/or a width of the base of these installation aid chain members are restricted.

It is expedient if the base is formed by a flexible elastomer band, in particular an endless elastomer band, and/or if the conductor holder is formed from a hard plastic, in particular a thermoplastic, and/or if the base and the conductor holder are formed by an endless plastic wire. Thereby, different options are indicated for an economical production of installation aid chain members.

It is furthermore expedient if the installation aid chain member is embodied having multiple parts, wherein the base, the at least one coupling arrangement and the conductor holder are preferably realized as separate individual components and are joined together detachably, in particular by inserting, or non-detachably, in particular by welding or bonding. Alternatively, provision can also be made that the installation aid chain member has multiple parts, wherein the base and the at least one coupling arrangement are formed jointly in a single primary shaping step, wherein the conductor holder is realized as a separate individual component and is joined detachably or non-detachably to the base, so that a partially monolithic installation aid chain member is formed. Finally, the installation aid chain member can be monolithic, wherein the base and the at least one coupling arrangement and the conductor holder are formed jointly in a single primary shaping step. This means that the installation aid chain member forms an integral structural unit. Thereby, preferred embodiments are indicated for an installation aid chain member. Multi-part installation aid chain members offer the technical advantage that materials can be used according to requirements for their individual components. For example, it can be conceived that a multi-part installation aid chain member has a conductor holder produced from a plastic, composite or a ceramic material, and a base produced from a further plastic, composite or a ceramic material, and a coupling arrangement produced from a further plastic, composite or a ceramic material. Monolithic installation aid chain members can be produced for example in a single primary shaping step, in particular injection moulding, whereby they are able to be produced rapidly and in large quantities.

Expediently, it can be additionally conceived that the installation aid chain member is produced from a perforated or otherwise contoured elastomer band, wherein plastic clip structures forming the conductor holders are inserted into the perforation openings. The elastomer band can have here a thickness of 3 to 8 mm. In particular, the elastomer band can have a Shore hardness which is dependent on a width of the elastomer band for the presenting of required radii. The plastic clip structures are expediently adapted to a strand diameter of the electric conductor.

It can also be conceived that the installation aid chain member is produced from a shaped elastomer band (extrusion cross-section) and is arranged for receiving an electric conductor with a defined conductor cross-section. Here, the dimensioning of wall thicknesses etc. and the Shore hardness of the elastomer band is dependent on winding radii which are to be produced.

It can also be conceived that the installation aid chain member is formed from a shaped elastomer band with reciprocal holding contour for receiving an electric conductor of a defined conductor cross-section.

It can also be conceived that the installation aid chain member is produced from a (thermally) bent plastic wire, e.g. PP, PA, whereby, as it were, an endless receiving structure is realized in the form of a reciprocal ring holding structure.

Another basic idea of the invention, which is able to be realized additionally or alternatively to the basic idea mentioned further above, can lie in indicating a mounting aid chain for the positioning and fixing of an electric conductor on a mounting area of an induction charging unit for a motor vehicle. Such a mounting aid chain has at least one base and at least one conductor holder, arranged thereon, for retaining a conductor portion of an electric conductor. Thereby, a preferred installation aid chain is indicated, which is formed from at least one base and one conductor holder. The base can preferably be realized here by a perforated elastomer band, and the conductor holder by c-shaped plastic clip structures, which are inserted into the perforated openings. The elastomer band here is preferably between 3 to 8 mm thick. Furthermore, the base and the conductor holder can be formed integrally by an elastomer band (extrusion cross-section). Furthermore, the base and the conductor holder can be formed by two elastomer bands, which are expediently intertwined with one another. Each of these elastomer bands can preferably have a portion of the base and conductor holder. Furthermore, the base and the conductor holder can be realized integrally by a bent plastic wire (e.g. PP, PA, or similar), which has reciprocal ring holding structures for constitution of the conductor holder.

Another basic idea of the invention, which is able to be realized additionally or alternatively to the basic idea mentioned further above, can lie in indicating an installation aid chain for the positioning and fixing of an electric conductor on a mounting area of an induction charging unit for a motor vehicle. This has several installation aid chain members, coupled to one another, according to the preceding description. Optionally, provision can be made that the installation aid chain members, forming a free chain end of the installation aid chain, respectively have only one single coupling arrangement, and the remaining installation aid chain members of the installation aid chain respectively have two coupling arrangements. Thereby, a preferred installation aid chain is indicated, which is composed of several installation aid chain members, wherein the individual installation aid chain members are coupled to one another by means of their coupling arrangements.

Another basic idea of the invention, which is able to be realized additionally or alternatively to the basic idea mentioned further above, can lie in indicating a coil arrangement of an induction charging unit for a motor vehicle. A coil arrangement has at least one installation aid chain according to the preceding description, arranged in the shape contour of a flat spiral or in another shape contour on a mounting area of the induction charging unit. Here, on the at least one installation aid chain an electric conductor, following the shape contour of the latter, is arranged and retained, so that a flat coil is formed. At this point, work can be carried out optionally with a cast body, in particular an epoxy resin, which at least partly or completely envelops and fixes the electric conductor and the several installation aid chain members of the at least one installation aid chain, wherein the cast body, on installation, is applied in a liquid processing state onto the electric conductor and the installation aid chain members of the installation aid chain, and is hardened. Expediently, through the adapting of the shape contour of the installation aid chain, for example the number of the coil windings and/or the length of the electric conductor can be predetermined so that the electromagnetic characteristics of the flat coil are adjustable within wide ranges. Thereby, further components of the induction charging unit, in particular a power electronics, communication electronics, safety electronics, electric connections, cooling connections and other necessary components of the induction charging unit, can be maintained in a structurally unchanged manner, even when the induction charging unit must be adapted to changed boundary conditions (for example a changed distance between the vehicle-side induction charging unit and a ground-side mutual induction charging unit, as a result of a different ground clearance of the motor vehicle). Through the cast body, an improved securing in position of the electric conductor can be achieved. In addition, through the cast body, a favourable heat flow to a heat sink can be set, whereby for example an efficient cooling of the flat coil can be realized.

Expediently, the installation aid chain can be configured or laid so that winding ends of the flat coil are arranged at the same position on the mounting area. Thereby, the electric conductor can always be guided at the same position to the electric components of the induction charging unit, in particular a power electronics, communication electronics, safety electronics, electric connections.

Furthermore, the coil arrangement can have a spacer grid which is arranged between the flat coil and magnetic field conductor elements of the coil arrangement, which serve for optimizing the magnetic characteristics of the flat coil. The magnetic field conductor elements can consist e.g. of a soft ferritic material or of another material with high relative permeability (e.g. □ᵣ > 10). The spacer grid preferably has passages through which a cast body, existing in liquid processing state, can flow. Thus it is possible for example to entirely pour out an installation space of the induction charging unit, in which the installation aid chain, the flat coil, the spacer grid and the magnetic field conductor elements are arranged, whereby an as a whole relatively robust coil arrangement or respectively induction charging unit can be provided, which is functional over the entire expected lifespan of a motor vehicle equipped with the induction charging unit.

Furthermore, in the installed state of the installation aid chain, a fixing means can be arranged between the bases of its installation aid chain members and the mounting area of the induction charging unit, which fixing means fixes the bases on the induction charging unit in a non-detachable or detachable manner. It is conceivable that the fixing means is realized by an adhesive, in particular a double-sided adhesive tape or spray adhesive, or an adhesive film, in particular a soft film of thermal interface material (TIM), which preferably has a thermal conductivity in the range of greater than 0.8 W/m*K to 2.0 W.m*K. Thereby a favourable heat flow can be set from the installation aid chain member to a heat sink, whereby for example an efficient cooling thereof can be realized.

The invention can comprise the alternative or additional further basic idea of indicating a method for producing a coil arrangement according to the above description for an induction charging unit of a motor vehicle. It comprises the steps:
1) Providing a flexible installation aid chain, in particular according to the above description, of several installation aid chain members, in particular according to the preceding description;
2) Positioning the flexible installation aid chain on a mounting area of the induction charging unit;
3) Arranging the flexible installation aid chain in a shape contour in the manner of a flat coil or in another preferred shape contour, by the installation aid chain members being displaced relative to one another;
4) Fixing the flexible installation aid chain on the mounting area, in particular bonding it on adhesively;
5) Form-fitting and/or force-fitting inserting of an electric conductor into the conductor holders of the installation aid chain members, whereby a flat coil is formed;
6) Optionally fixing the electric conductor onto the conductor holder of the installation aid chain members, in particular bonding adhesively.

Thereby, a preferred production method is described for a coil arrangement for an induction charging unit of a motor vehicle with the aid of an installation aid chain. It is self-evident that in the installation method just described, the sequence of the individual process steps can be interchanged and/or individual process steps can be combined with other process steps and/or can be dispensed with entirely, without departing from the scope of the described installation method.

Furthermore, additionally or alternatively provision can be made that the method steps of the method are executed manually or at least partly or entirely in an automated manner. It is also conceivable that the providing of a flexible installation aid chain according to step 1) is realized from an endless installation aid chain depot and/or that the providing of the electric conductor is realized from an endless conductor depot. Thereby, advantageous options are described, by which the above method can be optimized.

Expediently, the invention also relates to a use of an induction charging unit of a motor vehicle, arranged for charging a traction battery and equipped with at least one installation aid chain member or with an installation aid chain formed from a plurality of installation aid chain members.

Expediently, the invention can also relate to a further method for producing a coil arrangement according to above description for an induction charging unit of a motor vehicle, according to which a coil arrangement is provided with a spacer grid arranged between the flat coil and magnetic field conductor elements for conducting a magnetic field. Here, the spacer grid is provided with clearance passages, so that in the production of the coil arrangement a cast body, provided in liquid processing state, in particular an epoxy resin, can be applied and can penetrate through the passages.

In summary, it remains to be noted: The present invention relates preferably to an installation aid chain member for an installation aid chain, arranged for positioning and fixing an electric conductor, with a base which defines a support surface, via which the installation aid chain member is supported or is able to be supported, with at least one coupling arrangement, arranged on the base, for movable coupling of the installation aid chain member to at least one further installation aid chain member and with a conductor holder, arranged away from the support surface on the base, for retaining a conductor portion of the electric conductor. The invention further relates preferably to an installation aid chain composed of at least one installation aid chain member, a coil arrangement with the latter, and preferably a method for producing a coil arrangement for a vehicle-side induction charging unit with an installation aid chain.

Further important features and advantages of the invention will emerge from the subclaims, from the drawings and from the associated figure description with the aid of the drawings.

It shall be understood that the features mentioned above and to be explained further below are able to be used not only in the respectively indicated combination, but also in other combinations or in isolation, without departing from the scope of the present invention.

Preferred example embodiments of the invention are illustrated in the drawings and are explained more closely in the following description, wherein the same reference numbers refer to identical or similar or functionally identical components.

### BRIEF DESCRIPTION OF THE DRAWINGS

There are shown, respectively schematically

FIG. 1 shows a front view of a preferred example embodiment of an installation aid chain member according to the invention,

FIG. 2 shows a side view of an installation chain aid member of FIG. 1 according to an arrow II drawn there,

FIG. 3 shows a top view of the installation aid chain member of FIG. 1 according to an arrow III drawn there,

FIG. 4 shows in a top view, an installation aid chain composed of a plurality of installation aid chain members according to FIG. 1,

FIG. 5 shows in a top view, a portion of the installation aid chain of FIG. 4, but this is laid into a shape contour in the manner of a flat coil,

FIG. 6 shows a top view of the installation aid chain member of FIG. 1 according to an arrow III drawn here, but with an inserted position-securing element,

FIG. 7 shows an installation aid chain composed of a plurality of installation aid chain members according to a preferred further example embodiment,

FIG. 8 shows an installation aid chain composed of a plurality of installation aid chain members according to a preferred further example embodiment,

FIG. 9 shows an installation aid chain composed of a plurality of installation aid chain members according to a preferred further example embodiment,

FIG. 10 shows a coil arrangement of flat coil and installation aid chain, which is arranged in a vehicle-side induction charging unit of a motor vehicle,

FIGS. 11 to 15 show further installation aid chains according to different example embodiments.

### DETAILED DESCRIPTION

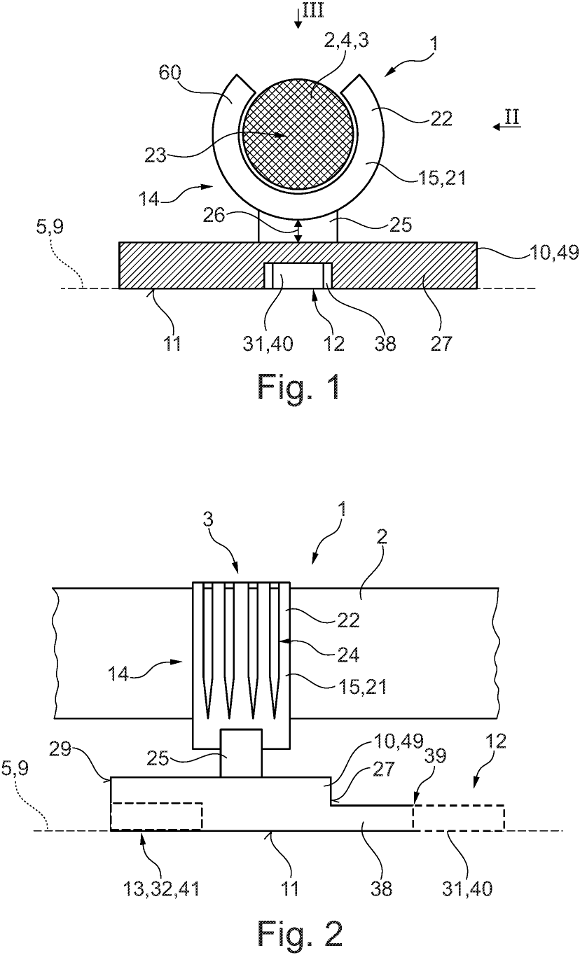

FIGS. 1 to 3 show a preferred example embodiment of an installation aid chain member, designated as a whole by reference number 1, firstly in a front view, then in a side view according to an arrow II drawn in FIG. 1 and lastly in a top view according to an arrow III, also drawn in FIG. 1.

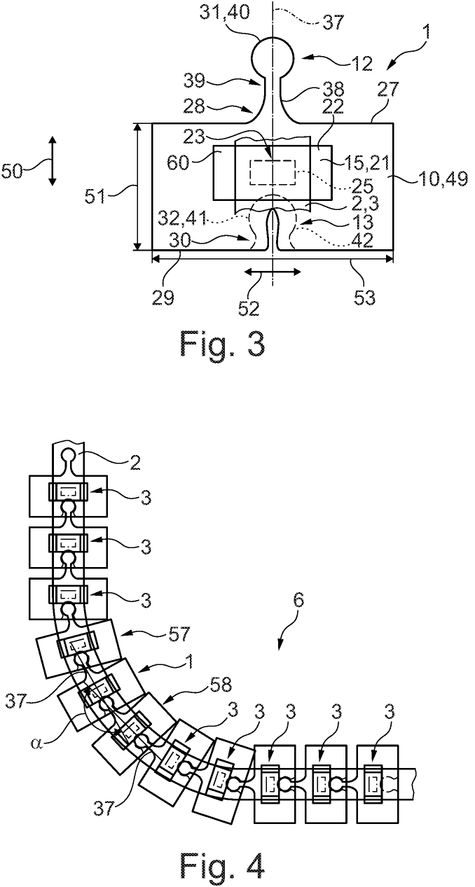

The installation aid chain member 1 according to the invention in accordance with FIGS. 1 to 3 has a base 10 which is formed by way of example by a cuboid-shaped flat body 49, which in its main extent direction 50 defines a base length 51 and, transversely to the main extent direction 50 in a transverse direction 52 defines a base width 53, cf. FIG. 3. The base 10 or respectively the planar body 49 defines a support surface 11, via which in installation aid chain member 1 is supported on a mounting area 5, indicated in FIGS. 1 and 2 by a dashed line, of an induction charging unit 9, not illustrated here, for a motor vehicle, which is also not illustrated. On the base 10 two integral coupling arrangements 12, 13 are provided, which serve for the movable coupling of the installation aid chain member 1 with at least one further installation aid chain member 57, 58 and are designated in the following, for simpler description, as first coupling arrangement 12 and second coupling arrangement 13. The installation aid chain member 1 has, furthermore, an integral conductor holder 14, arranged away from the support surface 11 on the base 10, which conductor holder retains, i.e. receives and fixes, a conductor portion 3, only partially illustrated in FIGS. 2 and 3, of an electric conductor 2 with a predetermined conductor cross-section 4.

The said conductor holder 14 has according to the example embodiment in accordance with FIGS. 1 to 3 a holding portion 15 for receiving and retaining the conductor portion 3 of the electric conductor 2, wherein by way of example provision is made that the holding portion 15 is realized by a two-winged clamp 21. Between the two clamping wings 22, 60, lying opposite with respect to one another, of the clamp 21 an internal clamping mount 23 is delimited, cf. FIG. 1, into which the conductor portion 3 of the electric conductor 2 is inserted here entirely, so that the clamping wings 22, 60 lie touching on the conductor portion 3 of the electric conductor 2 and clamp the electric conductor 2. Alternatively or additionally, the conductor portion 3 of the electric conductor 2 can also be fixed on the clamp 21 by means of an adhesive, which is not shown. At least one of the clamping wings 22, 60 has a slitting 24, which is directed transversely to the electric conductor 3 and simplifies the elastic clamping process.

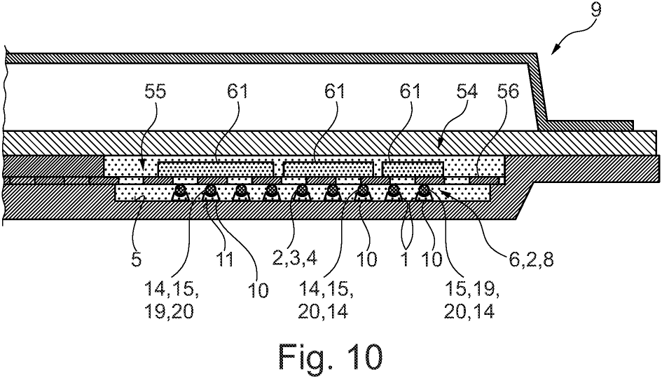

According to the example embodiment in accordance with FIG. 10, the said conductor holder 14 can have, alternatively, a holding portion 15 for receiving and retaining the conductor portion 3 of the electric conductor 2, which is realized by a recess mount 19, curved in a concave manner, on the recess support surface 20 of which the conductor portion 3 of the electric conductor 2 is received and fixed and preferably bonded adhesively.

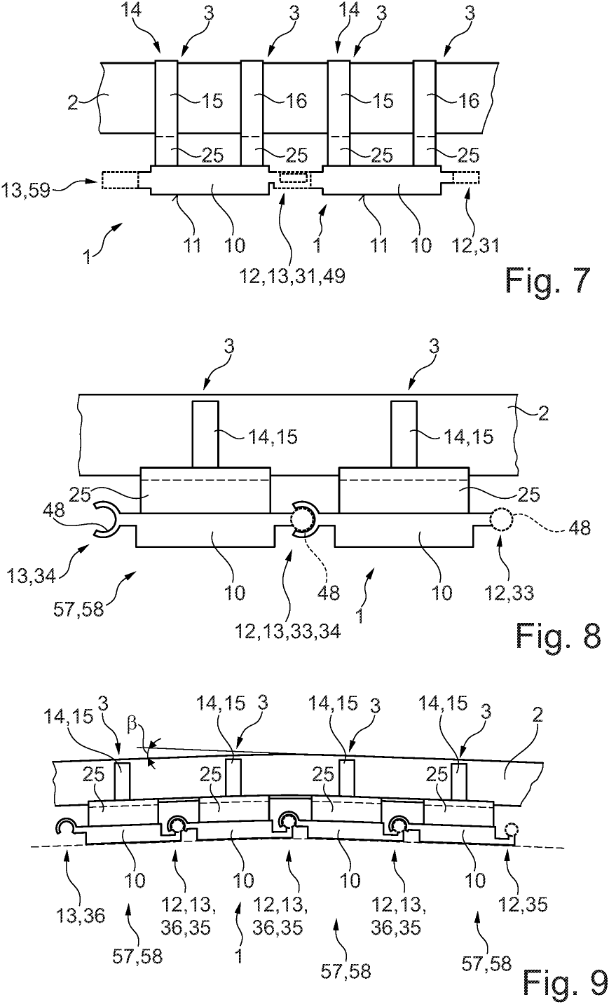

According to the example embodiment in accordance with FIG. 7 the said conductor holder 14 can have two separate holding portions 15, 16, wherein both holding portions 15, 16 can either be realized as recess mount 19 with recess support surface 20 or as a clamp 21 with clamping wings 22, 60.

In each case, the conductor holder 14 has, however, at least one support portion 25, which on the one hand is formed integrally on the at least one holding portion 15, 16 and on the other hand is either inserted on the base 10 or is likewise formed integrally therewith, so that the holding portion or respectively holding portions 15, 16 can rest on the base 10 via the support portion 25. The support portion 25 expediently defines here a holding portion-base distance 2, standing on the base 10 or respectively to be measured perpendicularly, which distance can be varied by a predetermined or predeterminable support portion component height of the support portion 25. Thereby, as it were, the installation aid chain member 1 can carry the conductor portion 3 of the electric conductor 2 with a predetermined or predeterminable distance with respect to a mounting area 5 of an induction charging unit 9.

The two said coupling arrangements 12, 13 are arranged on base end faces 27, 29 of the base 10 oriented opposed to one another, define in their main extent direction a so-called laying direction 37 and are formed in a complementary manner to one another, so that on both sides of the installation aid chain member 1 further installation aid chain members 57, 58 can be coupled in a form-fitting and/or force-fitting manner with complementary coupling arrangements, respectively matching thereto, cf. in particular FIG. 4.

According to the example embodiment in accordance with FIGS. 1 to 3, provision is made that the first coupling arrangement 12 of these two coupling arrangements 12, 13 has a bar-shaped or cone-shaped coupling projection 38, which is arranged on the first base end face 27 at its base end face centre 28 and projects over the first base end face 27 in the direction of the laying direction 37. The coupling projection 38 carries at its free end 39, facing away from the base end face 27 a coupling element 40 of the coupling arrangement 12, realized by a circular cylinder plate 31, which can be movably coupled with a coupling counter-element 41 of a further installation aid chain member 57, 58, configured in a complementary manner, realized by a circular cylinder plate recess 32.

The second coupling arrangement 13 of these two coupling arrangements 12, 13 is configured in a complementary manner to the first coupling arrangement 12 and has, for this, a coupling counter-element 41, arranged internally in the base 10, able to be movably coupled to a coupling element 12 of a further installation aid chain member 57, 58, and has a connecting neck 42, opening out on the one hand for instance in the base end face centre 30 on the second base end face 29 and on the other hand on the coupling counter-element 41. The coupling counter-element 41 is formed by way of example by a circular cylinder plate recess 32, formed integrally into the base 10, open on one side to the base surface 11, wherein for securing a circular cylinder plate 31 (coupling element 40) inserted therein, of a further installation aid chain member 57, 58, a position-securing element 48 is provided, inserted into the coupling counter-element 41 and/or into the connecting neck 42, cf. FIG. 6. Thereby, an unintentional disengaging of the installation aid chain members 1, 57, 58 can be efficiently prevented.

According to the example embodiment in accordance with FIG. 7, provision is made that the first coupling arrangement 12 is realized by an external circular cylinder plate 31, projecting outwards with respect to the base 10, and the second coupling arrangement 13 is realized by a likewise external circular cylinder plate mount 59, projecting outwards with respect to the base 10.

According to the example embodiment in accordance with FIG. 8, provision is made that the first coupling arrangement 12 is formed by an external ball bar 32, projecting outwards with respect to the base 10, and the second coupling arrangement 13 is formed by an external ball bar mount 34, projecting outwards with respect to the base 10. By way of example, the ball bar mounts 34 and/or the ball bars 33 are equipped respectively with a said position-securing element 48.

According to the example embodiment in accordance with FIG. 9, provision is made that the first coupling arrangement 12 is realized by an external ball hook 35, projecting outwards with respect to the base 10, and the second coupling arrangement 13 is realized by an external ball hook mount 36, projecting outwards with respect to the base 10. The ball head of the ball hook 35 can be seen here cranked upwardly, whereas the ball hook mount 36 is cranked downwardly or at least is downwardly open.

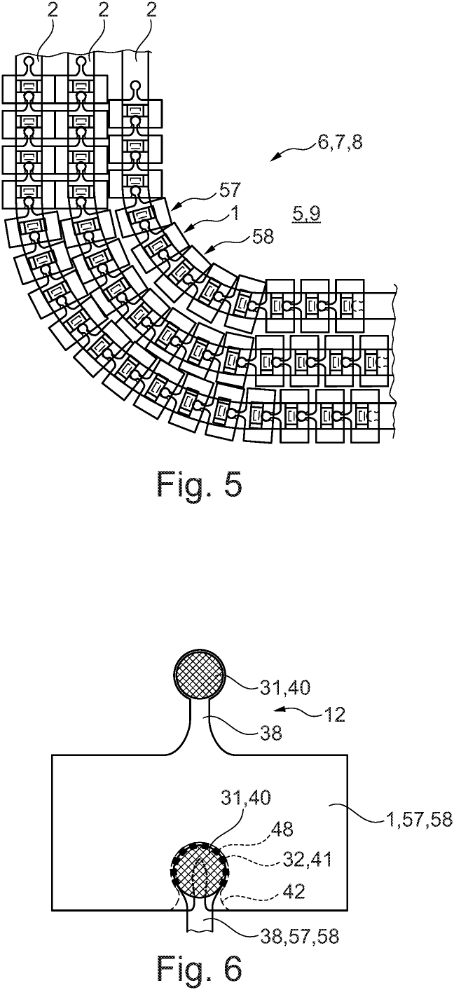

FIGS. 4 and 5 show respectively in a top view an installation aid chain 6 composed of numerous installation aid chain members 1, 57, 58 according to the example embodiment in accordance with FIGS. 1 to 3. The installation aid chain 6 is laid in accordance with FIG. 4 into a curve, and the installation aid chain 6 is laid in accordance with FIG. 5 into a shape contour 7 in the manner of a flat coil, the latter is, however, only partially illustrated. The installation aid chain members 1, 57, 58 of the installation aid chain 6 are movably coupled with one another here so that they can be displaced relative to one another for example to the sides, which is indicated in FIG. 4 with an angle □, and/or upwards and downwards, which is indicated in FIG. 9 with an angle □. Thereby, with an installation aid chain 6 optionally a flat curve shape or flat spiral shape or alternatively a three-dimensional curve shape or three-dimensional spiral shape, therefore as it were a vertical topology can be depicted. Thereby, the installation aid chain 6 can be laid at practically any contour of a mounting area 5 of an induction charging unit 9, practically without expenditure of force and relatively flexibly into a predetermined shape contour 7, for example into a spiral shape, and can be positioned via the support surfaces 11 of the bases 10 of its installation aid chain members 1, 57, 58 on the same mounting area 5 and can be fixed there if applicable with an adhesive. Thereby, a preferred installation aid chain 6 is indicated, which is composed of a plurality of installation aid chain members 1, 57, 58. In order to be able to position and fix an electric conductor 2 on a mounting area 5 of an induction charging unit 9 of a motor vehicle, provision is made that an electric conductor 2, for example an individual wire or a multi-core stranded wire, is arranged and retained on the installation aid chain members 1, 57, 58 in the conductor holders 14 thereof. Thereby, the electric conductor 2 can follow or respectively take over the shape contour 7 predetermined by the installation aid chain 6, so that on the mounting area 5 of the induction charging unit 9 by way of example, with regard to FIG. 5, a flat coil 8 is realized.

FIG. 10 shows a housing, not to be designated more closely, of an induction charging unit 9 with mounting area 5, wherein within the housing a coil arrangement 54 is arranged, which is equipped with a flat coil 8 provided with an installation aid chain 6 and an electric conductor 2, a spacer grid 56 and magnetic field conductor elements 61. The installation aid chain 6 and the electric conductor 2 are arranged in a spiral-shaped shape contour 7, which can not be seen here, so that the flat coil 8 as a whole is given a shape in the manner of a flat spiral. The magnetic field conductor elements 61 have the purpose of optimizing the magnetic characteristics of the flat coil 8, wherein by means of the spacer grid 56, which is arranged in a sandwich-like manner between the flat coil 8 and the magnetic field conductor elements 61, a predetermined distance can be set between the magnetic field conductor elements 61 and the flat coil 8. In FIG. 10 it can be seen furthermore that the coil arrangement 54 is embedded in a cast body 55. This cast body 55, in particular an epoxy resin, is applied on mounting of the coil arrangement 54 in a liquid processing state onto the electric conductor 2, the installation aid chain 6, the magnetic field conductor elements 61 and the spacer grid 56, so that these are at least partially or preferably completely wetted, and is subsequently hardened. Thereby, the components of the coil arrangement 54 are enveloped all around and are fixed to one another, whereby the coil arrangement 54 for example is more resistant with respect to impacts and environmental influences. So that the still liquid cast body 55 can wet the coil arrangement 54 as completely as possible during mounting, the spacer grid 56 is equipped with clearance passages through which the still liquid cast body 55 can flow. Expediently, through the adaptation of the shape contour 7 of the installation aid chain 6 for example the number of coil windings and/or the length of the electric conductor 2 can be predetermined, so that the electromagnetic characteristics of the flat coil 8 can be set within wide ranges. Thereby, further components of the induction charging unit 8, in particular a power electronics, communication electronics, safety electronics, electric connections, cooling connections and other necessary components of the induction charging unit can be maintained unchanged structurally, whereby the induction charging unit 9 is able to be produced in a relatively favourable manner and/or is able to be adapted to changing boundary conditions.

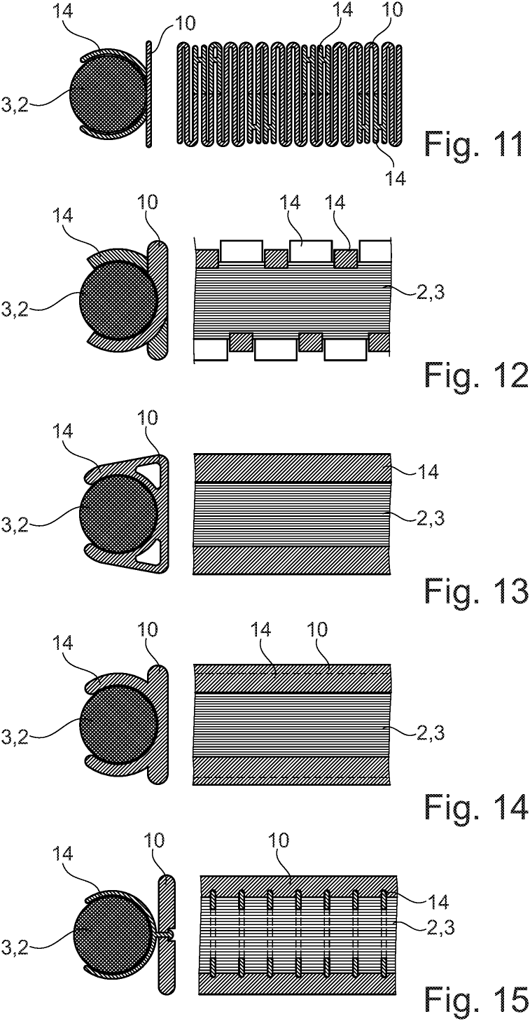

FIGS. 11 to 15 illustrate further preferred example embodiments for installation aid chains 6 for positioning and fixing an electric conductor 2 on a mounting area 5 of an induction charging unit 9 of a motor vehicle. These installation aid chains 6 have altogether a foundation designated as base 10, and at least one conductor holder 14, arranged thereon, for retaining a conductor portion 3 of an electric conductor 2. Base 10 and conductor holder 14 can be embodied integrally or separately here.

According to FIG. 11 provision can be made that the base 10 and the conductor holder 14 are realized integrally by a bent plastic wire (e.g. PP, PA, or similar), which has reciprocal ring holding structures for constituting the conductor holder 14. According to FIG. 12 provision is made that the base 10 and the conductor holder 14 are formed by two separate elastomer bands which are expediently interwoven with one another or are clipped into one another. Each of these elastomer bands can preferably form a portion of the base 10 and of the conductor holder 14. According to FIGS. 13 and 14 provision is made by way of example that base 10 and the conductor holder 14 are produced integrally by a single component, namely by an elastomer band (injection moulding cross-section). According to FIG. 15 for example provision is made that the base 10 is realized by way of example by a perforated elastomer band and the conductor holder 14 is formed by numerous c-shaped plastic clip structures which are inserted into the perforated openings of the elastomer band.

1. An installation aid chain member for an installation aid chain, the installation aid chain arranged for positioning and fixing an electric conductor , comprising:
a base defining a support surface, the support surface at least one of supporting and able to support the installation aid chain member;
at least one coupling arrangement (12, 13) arranged on the base for movably coupling the installation aid chain member to a second installation aid chain member; and
a conductor holder, the conductor holder arranged away from the support surface on the base, for retaining a conductor portion of the electric conductor.

2. The installation aid chain member according to claim 1, wherein:
the conductor holder includes at least one holding portion for receiving and retaining the conductor portion of the electric conductor; and at least one of:
the at least one holding portion (15, 16) is a recess mount, curved in a concave manner and on a recess support surface, the conductor portion of the electric conductorarranged in the recess mount;
the at least one holding portion is a two-winged clamp including two clamping wings, the two clamping wings lying opposite one another and at least one of delimiting and forming a clamping mount, the conductor portion of the electric conductor insertable into the clamping mount, and
wherein when the conductor portion of the electric conductor is inserted into the clamping mount, the clamping wings lie in a touching manner on the conductor portion of the electric conductor and clamp the electric conductor; and
the at least one holding portion is a u-shaped groove with an undercut, coordinated in a precisely fitting manner to the conductor portion of the electric conductor.

3. The installation aid chain member according to claim 2, wherein:
the at least one holding portion is arranged for receiving and retaining the conductor portion of the electric conductor such that electric conductors of different conductor cross-sections can be received and retained.

4. The installation aid chain member according to claim 1, wherein:
the at least one coupling arrangement is at least one of (i) formed integrally with the base and (ii) is provided as a separate component and is arranged on the base.

5. The installation aid chain member according to claim 1, wherein:
the installation aid chain member includes two coupling arrangements arranged on base end faces of the base, the base end faces oriented opposed to one another.

6. The installation aid chain member according to claim 5, characterized wherein:
the two coupling arrangements are at least one of (i) formed in a complementary manner to one another, and (ii) at least one of coupled and are able to be coupled respectively to a complementary coupling arrangement (12, 13) of the second installation aid chain member in at least one of a form-fitting and force-fitting manner.

7. The installation aid chain member according to claim 5 , wherein:
at least one of:
a first coupling arrangement of the two coupling arrangements is an external circular cylinder plate projecting with respect to the base, and a second coupling arrangement of the two coupling arrangements is an external circular cylinder plate mount projecting with respect to the base;
a first coupling arrangement of the two coupling arrangements is an external ball bar projecting with respect to the base, and a second coupling arrangement of the two coupling arrangements is an external ball bar mount projecting with respect to the base; and
a first coupling arrangement of the two coupling arrangements is an external ball hook projecting with respect to the base, and a second coupling arrangement of the two coupling arrangements is an external ball hook mount projecting with respect to the base.

8. The installation aid chain member according to claim 5 , wherein:
the two coupling arrangements define in their main extent direction a laying direction of the installation aid chain member, wherein the base end faces are oriented perpendicularly with respect to the laying direction;
a first coupling arrangement of the two coupling arrangements is external to the base and is arranged in at least one of in and in the region of a base end face centre on a first base end face of the two base end faces on the base; and
a second coupling arrangement of the two coupling arrangements is internal to the base and is arranged in the base and opens out in at least one of in and in the region of a base end face centre on a second base end face of the two base end faces (27, 29).

9. The installation aid chain member according to claim 8, wherein:
the first coupling arrangement includes a bar-shaped coupling projection arranged on the first base end face on the base, and a coupling element able to be movably coupled to a coupling counter-element , wherein the coupling projection projects over the first base end face in the direction of the laying direction and carries the coupling element at a free end; and
the second coupling arrangement includes a coupling counter-element arranged internally in the base and is able to be movably coupled to a coupling element, andincludes a connecting neck opening out at the second base end faceand at the coupling counter-element, cooperating with a coupling projection.

10. The installation aid chain member according to claim 9, wherein:
the coupling elementis at least one of a sphere, an ovoid , and a circular cylinder plate; and
the coupling counter-elementis at least one of (i) a spherical recess, open on one side, and formed integrally into the base,(ii) a hemispherical recess, open on one side, and formed integrally into the base, and (iii)a circular cylinder plate recess, open on one side, and formed integrally into the base.

11. The installation aid chain member according to claim 9, wherein:
at least one of the coupling counter-elementand the connecting neckof the second coupling arrangement includes elastic characteristics.

12. The installation aid chain member according to claim 1, wherein:
the installation aid chain member is at least one of: plurality of partssuch that the base, the at least one coupling arrangement and the conductor holder are separate individual components and are joined together at least one of detachably or non-detachably;
partially monolithic such that the base and the at least one coupling arrangement are formed jointly in a single primary shaping step, and the conductor holder is a separate individual component and is joined at least one of detachably and non-detachably to the base ; and
monolithic such that the base and the at least one coupling arrangement and the conductor holder are formed jointly in a single primary shaping step.

13. An installation aid chain for positioning and fixing an electric conductor on a mounting area of an induction charging unit for a motor vehicle, comprising:
at least one of:
a base and at least one conductor holder for retaining a conductor portion of the electric conductor; and
a plurality of installation aid chain members coupled to one another, according to claim 1; and
wherein the plurality of installation aid chain members includes installation aid chain members forming a free chain end of the installation aid chain , the respective installation aid chain members include a single coupling arrangement, and the remaining installation aid chain members of the plurality of installation aid chain members include two coupling arrangements.

14. A coil arrangement of an induction charging unit for a motor vehicle, comprising:
at least one installation aid chain according to claim 13, arranged in a shape contour of a flat spiral on a mounting area of the induction charging unit ;
wherein on the installation aid chain, an electric conductor following the shape contour thereof, is arranged and retained, which forming a flat coil; and
a cast body at least one of partially and entirely enveloping and fixing the electric conductor and the installation aid chain members of the installation aid chain, the cast body applied in a liquid processing state onto the electric conductor and the installation aid chain members of the installation aid chain, and is hardened.

15. A method for producing a coil arrangement for an induction charging unit of a motor vehicle according to claim 14, wherein:
a coil arrangement is provided with a spacer grid arranged between the flat coil and magnetic field conductor elements for conducting a magnetic field; and
the spacer grid is provided with clearance passages, such that in production of the coil arrangement, a cast body is provided in liquid processing state and is applied and penetrates through the clearance passages.

16. An installation aid chain member for an installation aid chain, comprising:
a base defining a support surface, the support surface supporting the installation aid chain member;
at least one coupling arrangement arranged on the base for coupling the installation aid chain member to a second installation aid chain member; and
a conductor holder arranged away from the support surface on the base and for retaining a conductor portion of the electric conductor, the conductor holder including at least one holding portion for receiving and retaining the conductor portion of the electric conductor.

17. The installation aid chain member of claim 16, wherein:
the at least one holding portion is a concave recess mount arranged on a recess support surface, the conductor portion of the electric conductor arranged in the recess mount.

18. The installation aid chain member of claim 16, wherein:
the at least one holding portion is a two-winged clamp including two clamping wings, the two clamping wings forming a clamping mount; and
the conductor portion of the electric conductor is insertable in the clamping mount, the two clamping wings lying on the conductor portion and clamping the electric conductor.

19. The installation aid chain member of claim 16, wherein:
the at least one holding portion is a u-shaped groove including an undercut; and
the u-shaped groove is form-fitting to the conductor portion of the electric conductor.

20. The installation aid chain member of claim 16, wherein:
the at least one coupling arrangement is formed integrally with the base.
